(19) United States
(12) Patent Application Publication
(10) Pub. No.: US 2024/0246013 A1
(43) Pub. Date: Jul. 25, 2024

(54) NANOPOROUS METAL FOAM GAS AND FLUID FILTERS

(71) Applicant: Georgetown University, Washington, DC (US)

(72) Inventors: Kai Liu, Falls Church, VA (US); James D. Malloy, Arlington, VA (US)

(21) Appl. No.: 18/598,834

(22) Filed: Mar. 7, 2024

Related U.S. Application Data
(63) Continuation-in-part of application No. 17/244,796, filed on Apr. 29, 2021.
Application No. 17/244,796 is a continuation-in-part of application No. 16/582,123, filed on Sep. 25, 2019.
Application No. 16/582,123 is a continuation of application No. PCT/US2018/026343, filed on Apr. 5, 2018.
(60) Provisional application No. 63/165,026, filed on Mar. 23, 2021.
(60) Provisional application No. 62/482,594, filed on Apr. 6, 2017.

(51) Int. Cl. B01D 39/20; B01D 46/24

(52) U.S. Cl. CPC B01D 39/2051; B01D 46/2403; B01D 2239/0471; B01D 2239/1216

(57) ABSTRACT

A metal foam-based filtration system and method for removing sub-micron particles and contaminants from a gas or fluid flow with the use of ultralow density metal nanowire meshes that have nanometer to micron scale pores for trapping air/fluid-borne particulates. Filters can use metal foams and coated metal foams alone or in tandem. The size and density of pores in the foam can be adjusted with synthesis conditions. Foams with pore size gradients promote the trapping of different sized particulates at different regions of a foam. Multiple rounds of electrodeposition increase the surface area and curvature of a nanowire mesh and strengthen the mesh. A metal and/or a coated metal foam can act as a catalyst or substrate for absorption or adsorption. Varying certain parameters can also impact the quality of the foam. Additionally, nanoparticles of about 300 nm in size can be directly incorporated into the foams.

### CROSS-REFERENCE TO RELATED APPLICATIONS

This application claims priority to and is a continuation-in-part of U.S. patent application Ser. No. 17/244,796 (the '796 application), which claims priority to and is a continuation-in-part of U.S. patent application Ser. No. 16/582,123 (the '123 application). This application also claims priority to U.S. provisional patent application No. 63/165,026 filed on Mar. 23, 2021. The '123 application claims priority to, and is a 35 U.S.C. § 111(a) continuation of, PCT international patent application number PCT/US2018/026343 filed on Apr. 5, 2018, which claims priority to and the benefit of U.S. provisional patent application No. 62/482,594 filed on Apr. 6, 2017. The preceding patent applications and provisional patent applications are incorporated herein by reference in their entirety.

The above-referenced PCT international application was published as PCT International Publication No. WO 2018/187633 on Oct. 11, 2018 and republished on Dec. 6, 2018, which publications are incorporated herein by reference in their entireties.

### STATEMENT REGARDING FEDERALLY SPONSORED RESEARCH OR DEVELOPMENT

This invention was made with Government support under DE-AC52-07NA27344, awarded by the U.S. Department of Energy (DOE). The Government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to gas filtration and pollutant arrester systems, and more particularly to devices and methods for nanoporous metal foam air and gas filters that are capable of efficiently filtering sub-0.3 micron sized particles through trapping, absorption, adsorption and/or catalytic reaction functions.

### 2. Background Discussion

Attempts to regulate particulate matter emissions in urban areas date back to the formation of sizable urban areas in the early stages of the industrial revolution. Even then, the relationship between particulate matter emissions and possible health effects, crop and vegetation damage and building discoloration and corrosion was apparent. Since that time, particulate matter emissions have been identified as causal factors in many health conditions, such as lung disease and related illnesses in humans, and in observed injuries to the environment.

Particulate matter (PM) is typically a complex mixture of micron sized organic or inorganic particles and liquid droplets that are classified according to size. Particles may include dusts; organic carbon compounds; salts in the form of nitrates, carbonates, chlorides, sulphates, etc.; oxides; heavy metals; black carbon, biological matter such as viral particles, and so on.

Serious health effects observed with exposure to particulate matter will also depend on the specific size, morphology and chemical composition of the particles. Because particles that are larger than 10 μm are effectively filtered out by the nose and upper respiratory tract, most air quality standards measure particles equal to or smaller than 10 μm. Particles with diameters that are between 2.5 μm (PM_{2.5}) and 10 μm (PM₁₀) are called coarse particles. Particles of less than 2.5 μm in diameter are called fine particles and particles of less than 0.3 μm (PM_{0.3}) are called ultra-fine particles.

Deleterious health effects associated with PM_{2.5} and PM_{0.3} particle exposures are believed to arise from both the small particle size and the particle composition. Fine and ultra-fine particles can be inhaled deeply into the respiratory system where they can trigger inflammation and a range of short and long-term symptoms and particles may even enter the circulatory system. Some groups of people are particularly sensitive to particulate pollution, such as individuals with heart or respiratory diseases. Short-term exposures to particulate pollution can aggravate lung diseases such as asthma and bronchitis, and may also increase susceptibility to respiratory infections. Long-term exposures may result in reduced lung function, chronic bronchitis, and lung cancer.

Fine particles may also remain suspended in the atmosphere and can travel long distances while polluting ground and surface waters, and may in some cases contribute to climate change. Persistent particle distributions in the atmosphere allow sources of particle pollution to combine in distant locations, thereby multiplying the effects.

Fine particles can be a significant fraction of particulate matter emissions from many sources globally. Over 90% of all particulates such as those found in smog are in the sub-0.3 micron regime, which pose the greatest health risks and are the most difficult to capture via filtering. While a key part of the solution to the problem of particulate pollution and other airborne particles rests in reducing emissions and suppressing pollutants at the source, equally important is the development of materials that can effectively capture fine and ultra-fine particles.

Strong public demand for particulate matter control has stimulated the development of several emission control technologies. For example, fabric filters, electrostatic precipitators, Venturi scrubbers and many other approaches have been developed for particulate matter control.

The size and chemical composition of the particles also determines the removal strategies and techniques that may be available. However, fine and ultra-fine particles can be relatively hard to collect from an emission stream. There are few effective filters for such small particles.

Conventional air filters, such as high-efficiency particulate air (HEPA) filters, are designed to capture large particulates, such as pollen and dust particles, that are over 0.3 microns in size. Current filter media with HEPA ratings, however, have such a high pressure drop that air flows are quickly reduced, limiting their ability to clean gases or air in even modestly sized rooms.

The danger posed by small airborne particles is further seen in the severe acute respiratory syndrome coronavirus 2 (SARS-COV-2) and the associated coronavirus disease 2019 (COVID-19). The coronavirus is approximately 0.1 μm in size and travels primarily through attachment to airborne particles and aerosols. Virus-laden aerosols are usually one micron in size or smaller and therefore are particularly dangerous. Their small size and ability to penetrate deep into one's respiratory system heighten the risk they pose to human beings. Unfortunately, some existing filter technologies have limitations that make them unsuitable for sustained use by the general population against viral particles.

For example, filters that use fiberglass fibers are fragile, deteriorate under high temperature and high relative humidity, and are difficult to thoroughly clean. Filters based on carbon nanotubes typically exhibit mechanical brittleness and, when broken, cause new particulates to become airborne. Polymeric fibers (e.g., polypropylene fibers used in HEPA and N95 facemasks) are vulnerable to degradation when exposed to ultraviolet (UV) radiation, organic solvents, and chlorine-based solutions, which makes them difficult to decontaminate and reuse. Further, continued reliance upon single-use face masks and/or other filters may pose environmental challenges due to the volume of masks and filters that are discarded on a daily basis.

Accordingly, there is a need for devices and schemes for the effective removal or reduction of fine and ultra-fine particles from air and gas flows, fluid flows, and/or emission streams.

### BRIEF SUMMARY

The apparatus and methods of the present technology for removing fine and ultrafine particles from a gas stream are centered generally on configurations of nanoporous metal foams and coated metal foams. Such foams have several exploitable electrical, magnetic, mechanical, optical and chemical properties due to their extremely high surface areas, nanoscale constricted geometries, and high porosity.

Nanoporous metal foams offer a platform for sub-0.3 micron particle collection by combining: 1) physical processes such as trapping and electrostatics/ionization to capture particulates; 2) absorption or adsorption of certain gases into the metal foam; and 3) catalytic reactions to neutralize toxic smog species by using the metal foams as catalysts, for example.

In some embodiments, a particle separation system for filtering gas and/or fluid processes a gas, fluid, or emission stream containing sub-0.3 micron particles with an optional pre-treatment module, a metal foam module, a coated foam module, and an optional post-processing module. Illustratively, the system can be configured with modules having characteristics directed to the removal of specific types of known particulates from an emission source or generalized for air purifications.

The pre-treatment module is designed to remove larger sized solids, aggregates or liquids from the gas or emission stream and may use conventional scrubbers, filters, and/or other collectors. The apparatus can be configured for use within the exhaust stream of existing systems to eliminate particles or for independent use to remove particles from the atmosphere. Many existing systems are not able to remove fine and ultrafine particles that may be released to the atmosphere.

The gas stream emerging from the pre-treatment module is preferably devoid of solid or liquid particulates that are larger than approximately 2.5 μm and preferably larger than 1.0 μm, which were removed by the module.

The metal foam module may use one metal foam or multiple metal foams having controlled dimensions, density, composition, pore size distributions, and/or other mechanical properties. A metal foam may have a single density or may feature two or more sections having different densities.

In some embodiments, the metal foam module has a continuously varying foam density producing a pore size gradient so that particles of different sizes collect in different regions of the metal foam. Further, several foams of different densities can also be aligned sequentially to capture particles of different sizes according to the pore sizes.

In other embodiments, foams of the same or different metals with different characteristics are paired. Conductive metal foams may also have a voltage applied in a further embodiment.

The second foam module may be a coated metal foam or may comprise a series of coated metal foams. Coatings of foam pores and surfaces can be selected based on chemical or electrical characteristics. For example, coatings may include carbon, a metal oxide, or a specific catalytic material.

Finally, the post processing module may induce changes in temperature, pressure, or condensation of any remaining materials in the fluid flow, as well as collect desirable gases or vapors.

Although a metal foam module and a coated metal foam module are discussed in tandem to illustrate some embodiments, in other embodiments single modules of either metal foams or coated metal foams, or multiple foams of different metals or coatings, can be configured.

A particle separation system described herein can be configured to take advantage of several different particle-trapping and chemical reaction mechanisms in concert and/or sequentially to collect the very small particles. For example, electrostatics and ionization effects can be exploited to attract small particles. In some embodiments, a metal foam is electrified and used as an ionization grid while a second foam coated with carbon or metal oxide is used to trap charged particles. Charged particles from the foam may alternatively be collected using a conventional charged plate or other means. Adsorption and desorption of offensive gases by the large surface areas of the metal and coated metal foams is another available pollutant-arresting mechanism.

Chemical or catalytic mechanisms are also available for emission neutralization. Both metal foams and coated or oxide foams may provide different catalytic or chemical activity. Metal foam coatings can be selected for specific activity toward target gases such as catalysts for gas chemisorption or physisorption. Current technologies in the art usually only use one type of physical or chemical mechanism to capture or neutralize certain species of particulates in emissions. The present technology combines several mechanisms to achieve the air cleaning goal, including physical processes such as trapping, ionization and electrostatics to capture particulates; absorption of certain offensive gas into the metal foam; and catalytic reactions to neutralize toxic smog species by using the metal foams as catalysts. As a result, the foams perform far better than currently existing technology.

According to one aspect of the technology, a gas or fluid filtering system uses metal foams that combine ultralight weight with a multitude of functionalities such as durability, renewability, tunability, reactivity and vast surface areas. They offer a completely new approach to combat the air pollution problem, in that the material properties can be tailored to achieve “smart” air filters.

Another aspect of the technology is to provide cost-effective, mass-producible, portable, durable and renewable devices that can provide personal protection, such as household air-filters and respirators that work in the sub-0.3 micron regime, wearable “catalytic clothing”, etc.

A further aspect of the technology is to provide an advanced method of treating and capturing contaminants such as smog, through trapping, absorption and/or catalytic reactions, that is cost effective, renewable and durable.

Another aspect of the technology is to provide a system and methods that can be tailored and adapted to collect particulates of specific sizes and chemical compositions.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWINGS

The technology described herein will be more fully understood by reference to the following drawings which are for illustrative purposes only:

FIG. 1 is a schematic system diagram of a particulate separator with pre-treatment, metal foam, coated foam and post processing modules according to some embodiments of the technology.

FIG. 2 is a schematic cross-sectional view of a gradient metal foam separator according to some embodiments of the technology.

FIGS. 3A-3F comprise SEM images of metal foams of different bulk densities according to some embodiments of the technology.

FIG. 4 is a photograph of an illustrative metal foam according to some embodiments of the technology.

FIG. 5 is a table depicting foam filtration characteristics according to some embodiments of the technology.

FIG. 6 comprises an SEM image showing the trapping of salt particles by metal foams according to some embodiments of the technology.

FIG. 7 is a histogram depicting measured versus calculated filtration quality, and filtration quality deviation between measured and calculated values according to some embodiments of the technology.

FIG. 8 is a graph showing the correlation between filtration quality deviation and percentage of surface features between 200-400 nm according to some embodiments of the technology.

FIG. 9 is a graph showing surface area of the foams versus coulomb deposited per mg of 1ED foam according to some embodiments of the technology.

FIG. 10 is a graph showing the correlation between filtration quality deviation and increased surface area contributed from deposited surface features according to some embodiments of the technology.

### DETAILED DESCRIPTION

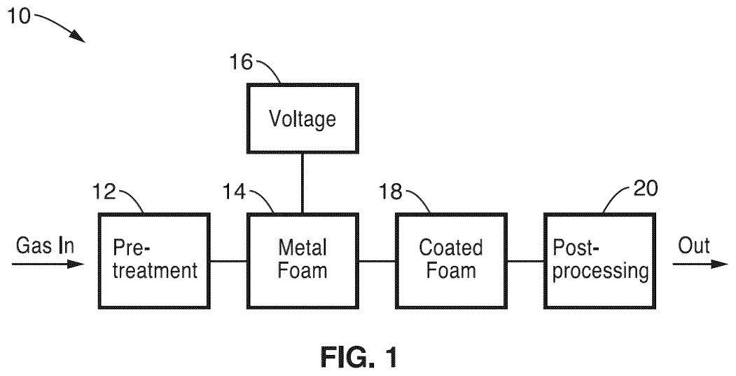

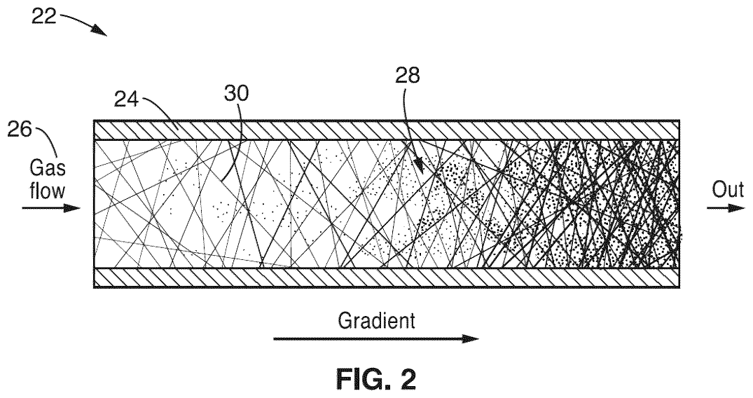

Referring more specifically to the drawings, for illustrative purposes, embodiments of systems and methods for fine and ultrafine particle separations from gas streams using low-density interconnected metal foams are generally shown. Several embodiments of the technology are described generally in FIG. 1 through FIG. 2 to illustrate the separation system and methods. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1, one embodiment of a particle separation system 10 is shown schematically to illustrate the adaptability of the system to different particle separations from a wide variety of gas or emission sources. In the embodiment shown in FIG. 1, particle separation system 10 includes a series of processing modules that may be individually configured to process specific gases or emissions and removal of specific types and/or sizes of particles. The modules can also be configured to provide different physical, chemical and electrostatic mechanisms to selectively remove particulates and/or other contaminants from a variety of sources.

In the embodiment illustrated in FIG. 1, the separation process generally begins with the introduction of a contaminated gas or fluid to pretreatment module 12. One purpose of pretreatment module 12 is to remove large particles from the input stream that could foul the smaller particle separators. The pretreatment module thereby helps prepare the input stream for fine and ultrafine particle separations in one or more subsequent modules. However, particles in a gas or fluid stream may be less than 0.3 μm in size, in which case pretreatment module 12 may be optional.

When employed, pretreatment module 12 can incorporate many existing large particle removal devices and schemes in the art, such as scrubbers, fabric separators, HEPA filters and the like. These devices/schemes function to remove larger particles and droplets and thereby reduce the size of particles remaining in the input stream to fine and ultrafine particles.

Pre-treatment module 12 may also prepare the input gas or fluid stream in some other manner for processing by the next module. For example, pretreatment module 12 can provide control over the temperature, pressure, and/or humidity of the stream that is introduced to metal foam module 14.

Many existing emission treatment systems are not capable of fine particle removals and instead are limited to removing larger particles. Modules subsequent to pretreatment module 12 of system 10 can be integrated into existing emission treatment systems to improve the performance of those systems.

Metal foam module 14 may be made with one or more metal foams contained in a single housing or an array of housings with gas inputs and outputs that allow gas to flow through the housing(s) and metal foam(s). The metal foams are preferably low cost and low density metal foams, with tunable densities between approximately 50% and approximately 0.01% by volume of the bulk density.

Several different fabrication schemes may be used to produce metal foams, including sol-gel methods, selective dealloying of a binary alloy (which involves selectively etching a less-noble metal from a bimetallic alloy), and combustion synthesis such as the thermal decomposition of transition-metal complexes containing high nitrogen energetic ligands.

One particular method of metal foam fabrication involves use of interconnected metallic ultrafine wires. The term ultrafine wire is used in a general sense for a nanoscale or micro-scale element and is intended to include a variety of structures such as tubes, rods, wires, ribbons, fibers, etc., which have dimensions on the nanometer to micron scale and are either solid or hollow. The metal wires may be made from pure metals such as Al, Ti, V, Cr, Fe, Co, Ni, Cu, Zn, Ga, Y, Zr, Nb, Mo, Ru, Rh, Pd, Ag, Sn, Sb, La, Nd, Sm, Dy, Pt, Au, Pb, and Bi, and/or from alloys based on one or more of these metals. Combinations of compatible metal wires can also be used to form the metal foams.

The metal wires are assembled into interconnected metallic foams that are mechanically strong. The voids or porous “pockets” inside the foam are adjustable, both in size and density, by tuning the synthesis conditions. The typical “pocket” size varies from nanometer scale to microns, ideally suited to trap the most harmful <0.3 μm sized particulates.

In some embodiments, fabrication of a metal foam involves forming a dispersion of selected metal nanowires in a liquid. The nanowire dispersion is then placed in a form and frozen. The frozen molded forms are then placed into a vacuum chamber and the frozen liquid sublimates under controlled conditions leaving a structure of interlocked nanowires. The loosely interlocked nanowire structure is sintered to bond the points of contact between the nanowires to form the final foam without significant increase in density.

The concentration or density of the nanowires within the dispersion and the nanowire dimensions can be controlled to tune the density of the final foam. The dispersion may be prepared with the density of nanoscale metal wires tuned to a given application over a continuous range from 0.01% to 50% by volume.

The tunability of the pore size and density as well as other aspects of the metal foams permits the foams to collect particles of predictable sizes. For example, metal foams with a pore size gradient can be achieved by continuously varying the foam density, so that particulates with different sizes will be trapped at different regions of the foam(s).

Referring also to FIG. 2, a separator 22 with a metal foam disposed in a housing 24 is shown schematically in cross-section. The metal foams of increasing densities of nanowires 30 and decreasing pore 28 sizes form a gradient. The particulates in the flow 26 of gas or emissions through the housing 24 will encounter smaller pores along the length of the housing 24 to the output in this embodiment.

In some embodiments, the metal foams of module 14 can be electrified with a controlled voltage from a voltage source 16. Charged metal foams can be used to produce electrostatic or ionization effects to trap very small particulates and gases.

Coated foam module 18 of system 10 of FIG. 1 receives the output of metal foam module 14. The foam or foams of module 18 are preferably coated with at least one metal oxide or a form of carbon. The metal oxide coating of a foam can be selected for its catalytic activity or characteristics of a specific target. The oxides can be coated onto metal foams using electroless deposition or atomic layer deposition, for example. Such metal foams can trigger chemical reactions and neutralize smog into harmless gases. Since the catalysts just facilitate the chemical reactions, they are not spent themselves; the foams therefore remain intact.

Although oxide coatings are discussed here, other coatings such as nitrides, chlorides, hydrides, fluorides, iodides, amines etc. may also or instead be used to coat a foam in module 18. Such coatings may be selected based on the reactivity of the coatings with constituents of the gas or emission flow. In addition, several different coated foams can be used in module 18 to produce a variety of different functionalities or characteristics.

The output from coated foam module 18 is optionally received by post-processing module 20 in the embodiments illustrated in FIG. 1. Post processing may include separating desirable gases in the filtered gas or fluid stream from undesirable gases. Collected undesirable gases such as CO, CO₂, H₂S, and SO₂ and others may be captured or processed further. Post processing at module 20 may also or instead include the use of condensers, scrubbers, and/or changes in pressure and/or temperature to treat or separate remaining components from the gas or fluid stream.

In addition to the physical mechanisms for trapping fine and ultrafine particles provided by the processing modules of FIG. 1, a particle separation system can also be configured to exploit electrostatic, ionization, and/or chemical mechanisms.

Electrostatic interactions have been commonly used to attract very small particulates. These interactions can be enhanced with a charged foam. For example, air ion emissions can transfer charges to an originally charge-neutral particle giving the particle an overall charge and thus enhance the electrostatic effect.

The conductive nature of the metal foams of module 14 and the voltage source 16 provides an additional handle to take advantage of this effect. For example, two metal foams can be used in tandem in the embodiments shown in FIG. 1. In particular, a charged first metal foam of module 14 can be used as an ionization grid, while a second metal foam of module 18 may be coated with a thin layer of carbon or TiO₂ that can act as a supercapacitor to attract and trap charged particulates.

Other mechanisms that can be utilized are absorption and adsorption of offensive gases by a metal and/or coated metal foam. Low-density foams have very large surface areas that can provide very effective mechanisms for absorption and/or adsorption. The absorption/adsorption effectively takes the offensive gases out of the environment.

A trapped gas can be released through a desorption process into a controlled exhaust under suitable temperatures and pressures. The cycle can repeat itself, thereby providing renewability of the foams. This feature may be applicable to primary smog gases, such as nitrogen oxides, carbon oxides, sulfur oxides, ammonia and ozone.

Chemical mechanisms may also be used for contaminant neutralization. The large surface/volume ratio in the metal foams and coated metal foams may drastically enhance the catalytic activity in comparison with bulk materials, leading to much higher chemical reactivity.

A variety of metal foams, such as those formed from Cu, Ni, Pd, Pt, Au, Ag, Pb, Sn, Ti, Fe, Co, Nb, Mo, Ta, W, and/or Al are good catalysts, which can trigger NO reduction, CO methanation or oxidation, ethylene hydrogenation, methane combustion or reaction with NO, methanol synthesis, etc.

Certain solid metal oxide semiconductors such as TiO₂, ZnO, V₂O₅, MoO₃, SiO₂, and NiₓCr₁₋ₓ MoₓP₁₋ₓO₄ are excellent photocatalysts. They can be excited by light with energy higher than the band gap, leading to electron-hole pairs that participate in a surface reaction, to trigger photodegradation of toxic contaminants. The oxides can be used to coat metal foams using a variety of methods such as electroless deposition or atomic layer deposition. Such metal foams can trigger chemical reactions and neutralize smog into harmless gases. Since the catalysts just facilitate the chemical reactions, they are not spent themselves; thus, the foams remain intact.

Other metal oxides for foam coatings can be selected based on the adsorption capacity, sensitivity and selectivity for target gases for removal from the effluent or gas stream. For example, MgO and CaO have been shown to destructively adsorb organophosphorus compounds. NH₃, SO₂ and CO₂ and other gases can be adsorbed on to metal oxides such as ZnO, WO₃, SnO₂, CaO, MgO, Fe₂O₃, TiO₂, ZrO₂, Li₂O, Li₂SO₄ and Al₂O₃, for example. Mixed metal oxides such as RuO₂—TiO₂, IrO₂—TiO₂, RuO₂—Co₃O₄—SnO₂—RuO₂ and others have been shown to have desirable activity and therefore can also be used as metal foam coatings. Metal oxide coatings may also be doped with reactive materials in some settings. Target gases may also be desirable gases for collection, such as hydrogen.

Metal foams in some embodiments described herein employ a single electrodeposition process, while fabrication of metal foams according to other embodiments may involve multiple rounds of electrodeposition to further increase the surface area of the metallic foam structure.

A second round of electrodeposition has been found to promote nucleation and the roughening of the coated nanowires, which partially accounts for the increased surface area and fiber surface curvature, and also increases the foam's effectiveness in intercepting airborne particles. Additional electrodeposition also helps stiffen the foam to withstand greater compressive stress.

Illustratively, a single electrodeposition process applied to bare nanowires may yield a coated metal foam having a bulk density around 1%. One or more subsequent electrodeposition processes may be customized to yield similar or greater bulk densities as discussed in one of the example implementations described below. An illustrative range of final densities is between 2% and 30%.

The technology described herein may be better understood with reference to the accompanying examples, which are intended for purposes of illustration only and should not be construed as in any sense limiting the scope of the technology described herein as defined in the claims appended hereto.

In order to demonstrate the functionality and operational principles of the particulate removing platform and methods, nanostructured palladium metal foams were fabricated and evaluated.

### Example 1

Polycrystalline Pd nanowires were fabricated by electrodeposition into porous templates, then harvested from the templates and suspended in water. Palladium nanowires were fabricated by electrodeposition from an aqueous solution of 6 mM PdCl₂+0.1 M HCl (1M=1 mol L⁻¹). Electrodeposition was performed at −450 mV relative to a Ag⁺/AgCl reference electrode into Au-coated (working electrode) anodized aluminum oxide (AAO) or track-etched polycarbonate membranes.

Nanowires with diameters of (10-200) nm and lengths of (3-20) μm were produced. After deposition, the Au working electrode was selectively etched using a solution of 0.4 M K₃Fe(CN)₆+0.2 M KCN+0.1 M KOH.

The AAO (polycarbonate) membranes were then dissolved by sonicating them in 6 M NaOH (dichloromethane). The nanowires were transferred to distilled or deionized water using a precipitation/decanting/solvent replacement technique.

Nanowires were then freeze-cast into foam monoliths. To construct the nanowire foam, the wires were allowed to precipitate out of solution and the water level was adjusted to the nominal final volume of the foam. The settled nanowires were then sonicated to develop a randomly dispersed slurry, which was immediately immersed in liquid nitrogen, freezing the wires in a random distribution in the ice matrix.

The frozen slurry was then placed in vacuum (<0.1 Pa) for >12 h to sublimate the interstitial ice, leading to the pure Pd nanowire foam. The mechanical strength of the foam was further enhanced by sintering.

Scanning electron microscopy, and high-resolution transmission electron microscopy was performed on both the foams and individual wires. Scanning electron microscopy micrographs confirmed the highly porous structure of the fabricated foams. For Pd foams composed of 200 nm diameter, 15 μm long wires, the foam density was tunable between 12 and 135 mg cm⁻³, corresponding to a density that is only 0.1-1% of bulk Pd.

This synthesis approach is scalable for industrial applications, as wet chemistry-based solution synthesis is well suited for mass production of nanowires and industrial sized freeze-drying devices are readily available. In this work, we focus on an example monolith which has a density of 41±3 mg cm⁻³ and surface area of 6.9±0.1 m² g(Pd)⁻¹ (the confidence interval represents one standard deviation, and is determined by the accuracy of the measurement tools); porosity measurements show that the foam has few constricted volumes (e.g., cavities or cracks).

### Example 2

To further demonstrate the capabilities of the metal foams, the Pd metal foams were evaluated for gas storage capacity and as a catalyst. Hydrogen absorption/desorption measurements were performed using a commercially available precision gas dose controller with forked sample tube and a Calvet-type twin microcalorimeter.

Equilibrium was defined as a pressure change of <0.01% over 10 s. Thermodynamic measurements were performed using a constant temperature (37° C.), incremental dosing approach and by integrating the heat flow from the calorimeter. Rate of adsorption (ROA) measurements were also performed.

The X-ray diffraction (XRD) pattern of the Pd nanowires showed the Pd (111) and (200) peaks, identifying a cubic lattice parameter of a=3.86±0.01 Å, consistent with bulk values. After a 1 h exposure to ˜200 kPa hydrogen (at 25° C.), the peaks shifted to lower 20 values as a increased to 4.00±0.01 Å, signaling the formation of PdHₓ.

The hydrogen could be desorbed by heating (250° C. for 30 min in air) or vacuum (30 min, 25° C., P_{Base}<0.01 Pa), as indicated by the shifting XRD peaks. Translation of the peaks, rather than broadening or splitting, indicates that the hydrogen penetrates the entire wire uniformly, compared to bulk palladium in which penetration is limited by the rate of hydrogen diffusion. Interestingly, after successive hydrogen exposures, the PdHₓ(111) peak shifted to lower angles, indicating the lattice parameter for the PdHₓ increases with cycling, corresponding to enhanced hydrogen absorption.

Palladium foam monoliths demonstrated excellent characteristics for hydrogen storage applications, including their hydrogen loading capacity, rate of absorption, and heat of absorption. The hydrogen absorption/desorption process is highly hysteretic, along with substantial lattice expansion/contraction as the foam converts between Pd and PdHx. Such foams with pristine metal surfaces are also suitable for use as catalysts.

### Example 3

Electrochemical deposition of Cu into anodized aluminum oxide (AAO) templates 60 μm thick and having pores of 0.2 μm was carried out in 240 g/L copper sulfate (CuSO₄) electrolyte with an applied potential of −200 mV relative to a Ag⁺/AgCl reference electrode. Nanowires were subsequently liberated by dissolving the AAO in a strong base solution (e.g., 6M sodium hydroxide (NaOH)). After the liberated nanowires sank to the bottom of the solution, fluid exchanges were used to replace the solution with deionized water. At this point, the density of the initial metallic foam can be tuned between 0.1% and 2% of bulk density by adjusting the ratio between the water and the nanowires. The nanowire/water suspension was then frozen in liquid nitrogen and pumped in vacuum (<0.1 Pa for >12 h) to sublimate the ice. The resultant free-standing and self-supporting foam was strengthened by sintering at 300° C. and simultaneously undergoing multiple oxidation/reduction cycles. In each cycle, the Cu foam was oxidized by exposure in air and then reduced using a forming gas (e.g., 5% hydrogen, 95% nitrogen).

In this example, foams with densities equal to approximately 1% of the Cu bulk density were achieved after this first synthesis of electrodeposition and sintering (referred to as 1ED-Cu hereafter). Such foams have extremely large surface area-to-volume ratios, up to 10⁶:1 m⁻¹ that are highly effective for filtration. These foams were further strengthened with a second electrodeposition step (referred to as 2ED-Cu hereafter) such that the final foam density was tuned between 2% and 30% of Cu bulk density.

The second electrodeposition process differed from the first in that it was carried out using 240 g/L CuSO₄+0.48 mg/L NaCl+3.1 g/L Polyethylene Glycol (PEG-10000 (C₂ₙH₄ₙ₊₂Oₙ₊₁))+1.7 mg/L 1-(2-Hydroxyethyl)-2-Imidazolidinethione (C₅H₁₀N₂OS)+1.7 mg/L Janus Green B (C₃₀H₃₁ClN₆)+0.6 mg/L Thioglycolic Acid (C₂H₄O₂S) with an applied potential of −200 mV relative to a Ag⁺/AgCl reference electrode. The inclusion of cuprous intermediates, formed by the interaction of Cu salts with the additives, affected the overpotential and the kinetics of the copper deposition at the substrate surface. Here, polyethylene glycol (PEG) was used as a suppressor, Janus Green B and 1-(2-Hydroxyethyl)-2-Imidazolidinethione as leveling agents, and thioglycolic acid as an accelerator. Other suppressors, leveling agents, and/or accelerators may be employed in other environments or embodiments. The thickening and density of the metal foam that results from this second electrodeposition step can be controlled by adjusting the total amount of deposited materials.

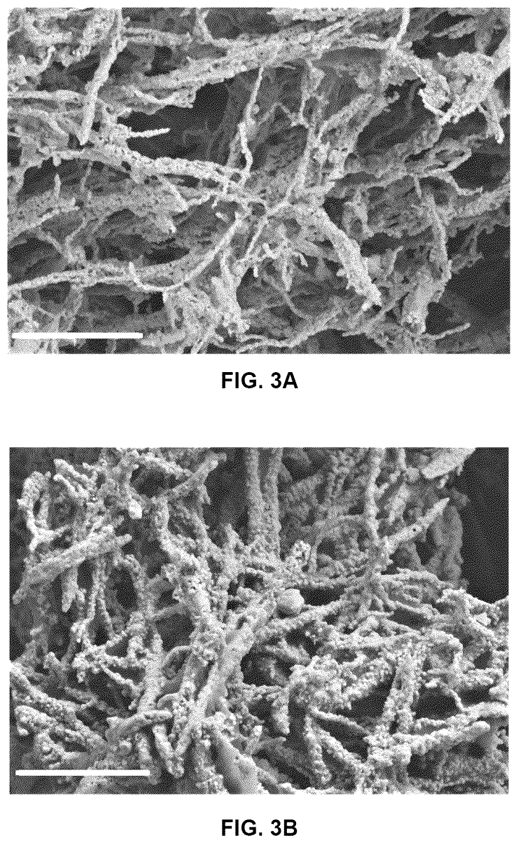

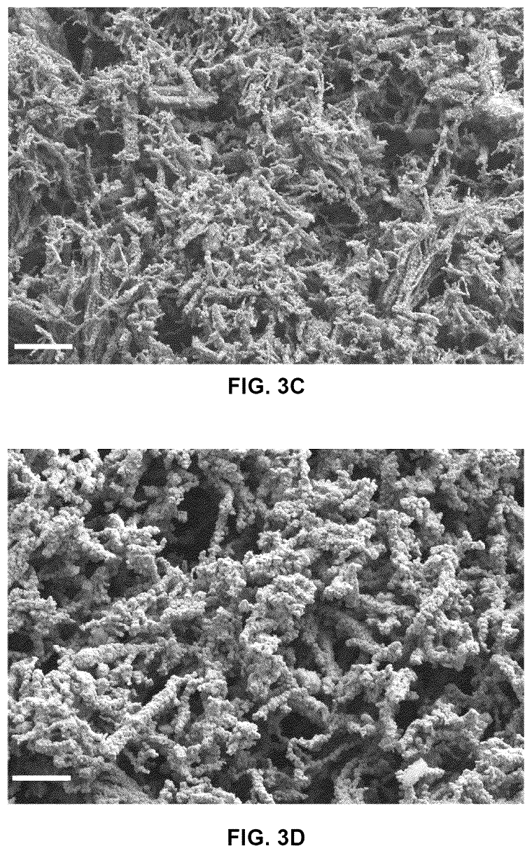

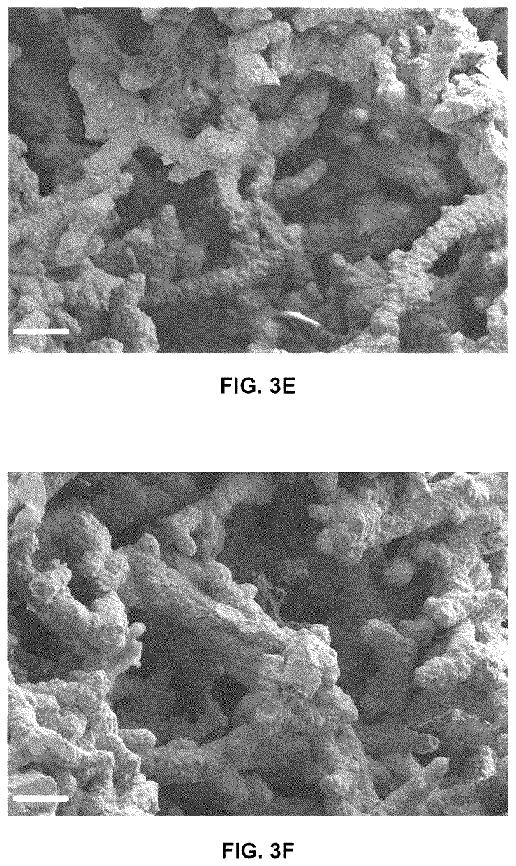

2ED-Cu foams plated to 5%-30% bulk density were examined with scanning electron microscopy (SEM). Images of 5%, 15% and 30% bulk density meal foams are shown in FIGS. 3A-F; the scale bar in each image corresponds to 10 μm. The images of FIGS. 3A-F demonstrate the three-dimensional, rigid, physically interlocked structure of the metal foams.

For a 5% density foam, SEM images show that the arbitrary arrangement of interconnected nanowires creates a highly porous structure. In addition, nanowire diameter increases substantially from the initial 0.2 μm size after the 1st ED to up to 0.5 μm in the foam interior (FIG. 3A) and 0.9 μm on the foam exterior (FIG. 3B) after the 2nd ED process. Importantly, thickening of the foam not only occurs along individual nanowires but also at intersections of nanowires, creating a three-dimensional scaffold over the 1ED-Cu foam where the contact areas between intersecting nanowires are increased by over an order of magnitude. This step significantly enhances mechanical stability of the foam.

SEM images of the 5% 2ED-Cu foam interior reveal that the nanoporous foam morphology is preserved along the sample thickness. Moreover, the 2nd ED process created numerous tiny granular textures along the nanowires, with sizes ranging from approximately 0.1 μm to 0.5 μm. These nucleation/growth sites further increase the overall surface area and surface curvature of the foam.

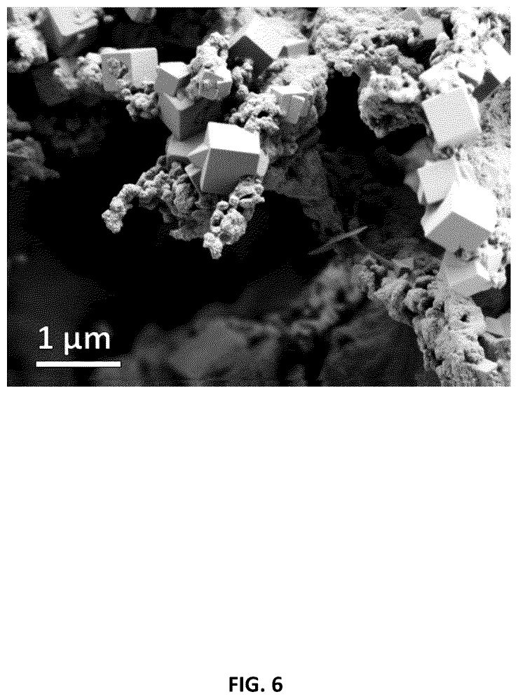

In a 15% density foam, nanowire diameter has increased to approximately 1.1 μm in the foam interior (FIG. 3C) and 1.9 μm on the exterior (FIG. 3D), but surface roughness may slightly decrease as the 2ED nucleation sites increase in size and begin to coalesce. In a 30% density foam, the average nanowire size has increased to approximately 5 μm in the foam interior (FIG. 3E) and 6 μm on the exterior surface (FIG. 3F). Surface roughness is further reduced as the 2ED forms a contiguous coating over the 1ED foam.

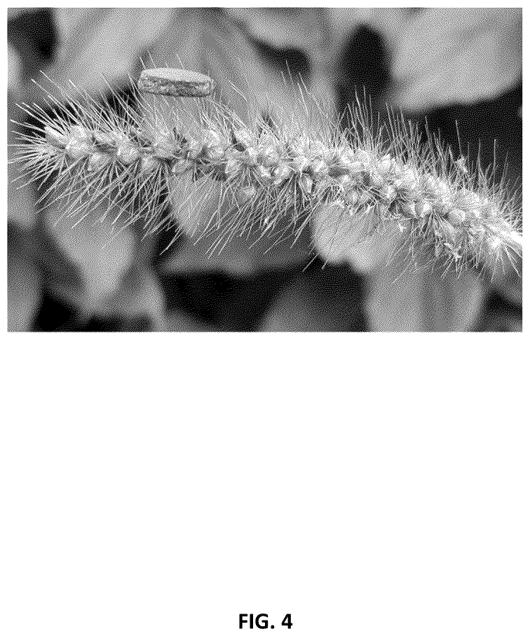

An illustrative implementation of a 15% 2ED-Cu foam disc 1.4 mm thick and 9 mm in diameter weighs approximately 120 mg but can support a 1 kg weight without collapsing. FIG. 4 illustrates such a metal foam disc resting upon bristles of a green foxtail plant (Setaria viridis) without bending them. Other illustrative foams range in thickness from less than 1 mm (e.g., 0.8 mm) to multiple millimeters. Metal foams and coated metal foams described herein can be easily cleaned of particles and particulate matter through rinsing in water or other cleaning agents, sonication, and/or treatment with a stream of compressed air.

From the description herein, it will be appreciated that that the present disclosure encompasses multiple embodiments which include, but are not limited to, the following:
1. A metallic foam structure for air and gas purifications, comprising: an interconnected ultrafine metallic wire network, the metallic wire network having a plurality of nanometer to micron scale pores; and a coating on exterior surfaces of the metallic wire network and pores to produce a coated metallic foam.
2. The metallic foam structure of any preceding or following embodiment, wherein the coating comprises a catalytic metal oxide selected from the group consisting of TiO₂, ZnO, V₂O₅, MoO₃, SiO₂, and NiₓCr₁₋ₓ MoₓP₁₋ₓO₄.
3. The metallic foam structure of any preceding or following embodiment, wherein the coating comprises a metal oxide selected from the group consisting of WO₃, SnO₂, CaO, MgO, Fe₂O₃, ZrO₂, Li₂O and Al₂O₃.
4. The metallic foam structure of any preceding or following embodiment, wherein the coating comprises a mixed metal oxide.
5. The metallic foam structure of any preceding or following embodiment, wherein the coating comprises a layer of carbon.
6. The metallic foam structure of any preceding or following embodiment, wherein the metal nanowire network is formed from one or more metals selected from the group of metals consisting of Al, Ti, V, Cr, Fe, Co, Ni, Cu, Zn, Ga, Y, Zr, Nb, Mo, Ru, Rh, Pd, Ag, Sn, Sb, La, Nd, Sm, Dy, Pt, Au, Pb, and Bi, and alloys of one or more of these metals.
7. The metallic foam structure of any preceding or following embodiment: wherein the metallic nanowire network having a plurality of nanometer to micron scale pores forms a pore size gradient across a dimension of the coated metallic foam; and wherein particles of different sizes passing through the coated metallic foam will collect in different regions of the coated metallic foam.
8. The metallic foam structure of claim 1, further comprising: an uncoated interconnected ultrafine metallic wire network coupled to the coated metallic foam; the uncoated metallic wire network having a plurality of nanometer to micron scale pores to produce an uncoated metallic foam.
9. The metallic foam structure of claim 8, wherein the uncoated metallic nanowire network is formed from one or more metals selected from the group of metals consisting of Al, Ti, V, Cr, Fe, Co, Ni, Cu, Zn, Ga, Y, Zr, Nb, Mo, Ru, Rh, Pd, Ag, Sn, Sb, La, Nd, Sm, Dy, Pt, Au, Pb, and Bi, and alloys of one or more of these metals.
10. The metallic foam structure of claim 8: wherein the uncoated metallic nanowire network having a plurality of nanometer to micron scale pores forms a pore size gradient across a dimension of the uncoated metallic foam; and wherein particles of different sizes passing through the uncoated metallic foam will collect in different regions of the uncoated metallic foam.
11. A fluid filtration system for removing particulates and contaminants from a fluid flow, comprising: a filter housing with an interior, an intake port and an output port; and at least one filter element disposed within the interior of the housing; the filter element comprising a metal foam of an interconnected ultrafine metallic wire network; the network having a plurality of nanometer to micron scale pores.
12. The system of claim 11, wherein the metal foam has a density from about 20 g/cm³ to about 1 mg/cm³.
13. The system of any preceding or following embodiment, the filter element further comprising: a plurality of metal foams, each foam having a different density aligned sequentially according to density and forming a density gradient within the housing.
14. The system of any preceding or following embodiment, further comprising: a voltage source electrically coupled to the metal foam.
15. The system of any preceding or following embodiment, further comprising: a second filter element coupled to the first filter element within the interior of the housing; the second filter element comprising: (i) at least one interconnected ultrafine metallic wire network, the network having a plurality of nanometer to micron scale pores; and (ii) a coating on exterior surfaces of each metallic wire network and pores to produce a coated metal foam.
16. The system of any preceding or following embodiment, further comprising: a voltage source electrically coupled to the metal foam; and a second filter element of a coated metal foam of an interconnected ultrafine metallic wire network coated with a catalytic metal oxide or carbon, the second filter element adjacent to the first filter element within the interior of the housing; wherein a voltage applied to the metal foam of the first filter element functions as an ionization grid configured to transfer charges to charge neutral particulates; and wherein the second filter element coated foam layer traps charged particles within the pores of the coated foam.
17. The system of any preceding or following embodiment, further comprising: a pre-filter coupled the intake port of the filter housing, the pre-filter configured to remove particulates larger than about 2.5 microns from a fluid flow.
18. A method for removing particulates and contaminants from a fluid flow, the method comprising: forming a nanostructured metal foam, the foam having a plurality of nanometer to micron scale pores; and flowing fluid over or through the metal foam trapping fluid borne particulates within the micron scale pores of the foam.
19. The method of any preceding or following embodiment, further comprising: controlling synthesis conditions of the metal foam formation thereby adjusting the size and density of pores within the metal foam.
20. The method of any preceding or following embodiment, further comprising: continuously varying the pore density of the formed metal foam to produce a pore size gradient; wherein different sized particulates will be trapped at different regions of the metal foam.
21. The method of any preceding or following embodiment, further comprising: coating the pores of the nanostructured metal foam with a coating selected from the group of coatings consisting of carbon, an oxide, a nitride, a chloride, a hydride, a fluoride, an iodide and an amine.
22. The method of any preceding or following embodiment: wherein the metal foam coating is a catalytic metal oxide; and wherein the catalytic metal oxide triggers chemical reactions and neutralizes contaminants.
23. The method of any preceding or following embodiment, further comprising: flowing a stream of gases containing charge neutral particulates over or through the metal foam; applying a voltage to the metal foam to transfer charge to the charge neutral particulates in the stream of gases; and collecting the charged particulates.
24. The method of any preceding or following embodiment, further comprising: forming a second nanostructured metal foam with a plurality of nanometer to micron scale pores, the second nanostructured metal foam coated with a catalytic metal oxide; and collecting the charged particulates in the pores of the second nanostructured metal foam.
25. The method of any preceding or following embodiment, further comprising: forming a second nanostructured metal foam with a plurality of nanometer to micron scale pores, the second nanostructured metal foam coated with a catalytic metal oxide; flowing contaminated gases through the first and second metal foams; adsorbing contaminants from the flow of contaminated gases within the pores of the two metal foams; and desorbing contaminants from the two foams by exposing the foams to a change in temperature and pressure.

In example embodiments, varying parameters such as electrolyte species and additives, pH value of electrolyte, starting nanowire diameter, and electrodeposition time, can impact the quality of foam (e.g., metal foam 14) including, for example, its initial density, final density, thickness, nanogranule feature size on the foams, and foam filtration characteristics.

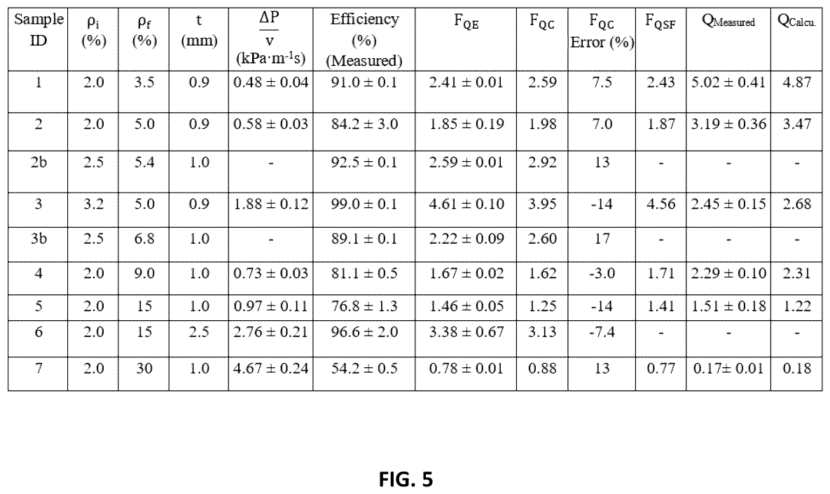

FIG. 5 depicts a characteristics table that shows some results from variations of these parameters, which led to a very wide range of tunability in breathability, capture efficiency, and overall filtration quality and mechanical strength. The table includes, for each identified sample (e.g., Sample ID) of metal foam, initial density ρᵢ, final density ρ_{f}, thickness t, pressure differential ΔP/v; measured PM_{0.3} filtration efficiency; measured, calculated and surface-feature corrected filtration qualities (F_{QE}, F_{QC} and F_{QSF} respectively); and the measured quality factor Q_{MEASURED} and calculated quality factors Q_{CALCULATED}.

Still referring to FIG. 5, various metal foam (e.g., metal foam 14) samples were fabricated as described above. In example embodiments, nanoporous copper foams were fabricated using electrodeposited nanowires (NWs). Anodized aluminum oxide (AAO) templates with 200 nm pore size and 60 μm thickness were used for the electrochemical deposition (ED) of Cu NWs. Subsequently, NWs were liberated from the AAO membrane into deionized water. The NW-water suspension was then freeze-cast by liquid nitrogen into the desired shape and then pumped in vacuum to sublimate the ice. The resultant free-standing foam was strengthened by sintering at 300° C., while simultaneously undergoing multiple oxidation/reduction cycles. The initial density (ρᵢ) of the foam can be tuned by adjusting the density of nanowires suspended in the deionized water during the flash freezing process. While foams with an initial density ρᵢ˜2-3% of the Cu bulk density were fabricated and evaluated in example embodiments, initial densities spanning a much wider range (from 0.1-10%) can be fabricated using this process as well.

Subsequently, the nanoporous copper foams were strengthened further using a secondary electrodeposition (2ED) step to achieve a final density ρ_{f}, in an electrolyte solution bath of copper sulfate along with a mixture of leveler, accelerator, and suppressor compounds (Janus Green B, thioglycolic acid, polyethylene glycol, respectively) to achieve even and homogeneous plating. The resulting foams were significantly stronger and more durable due to increased bonding areas at intersections of nanowires, while still retaining a high surface area and an excellent filtration efficiency.

The morphology of the foams varied widely depending on the amount of secondary electrodeposition as well as other factors. The diameter of the nanowires can be tuned very easily by adjusting the amount of copper plated during the electroplating process, from 200 nm found in the ultra-low density foams with ˜2% density to 6 μm found in the 30% density foams. It was found that deep sub-micron diameter nanowires made using this method are critically important for making the highest efficiency filters. As can be seen in FIG. 5, the most effective 99% efficiency filter was fabricated by increasing the initial nanowire density and adjusting the amount of plating, for example by limiting the amount of plating, during the secondary deposition to keep the nanowire diameter small. The pH was kept between 3-4 by adjusting the amount of sulfuric acid during the secondary plating solution to encourage optimal feature size growth throughout the foam.

The size of nanogranules on a foam surface can be controlled. Particles are captured more easily when they can nest into crevices which increase the area of contact between the fiber and particle, leading to a higher sticking coefficient. This can be seen in FIG. 6, wherein the salt (NaCl) crystals tend to be wedged into crevices with a higher area of contact.

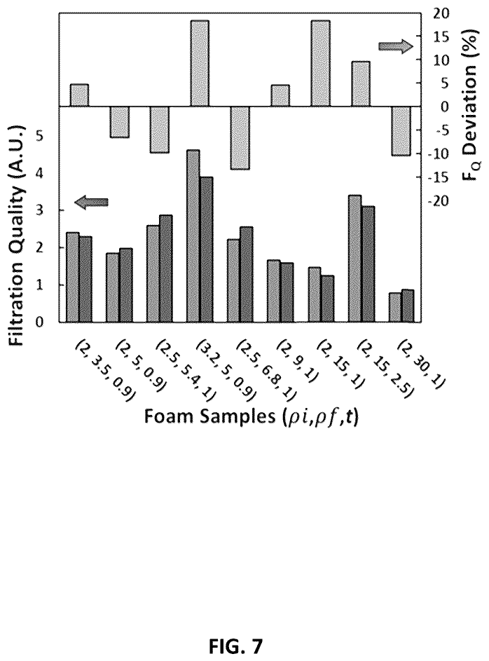

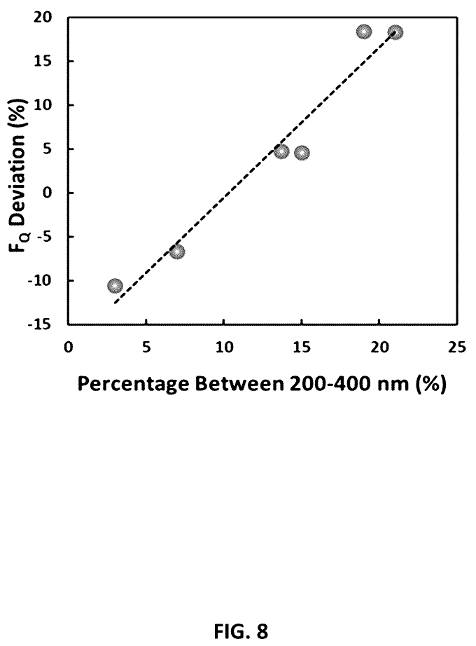

Quantitative image analysis on scanning electron microscopy (SEM) micrographs was performed on foam samples of various densities to determine the feature size distribution across samples. We find that the increased particle capture due to nesting is maximized when surface features along the nanowires are similar in size to the particles being captured, and becomes diminished as the surface features become too large or too small relative to the particles. FIG. 7 shows the measured filtration quality (bottom light gray bar) versus calculated filtration quality (bottom dark gray bar), and the filtration quality deviation between measured and calculated values. While the theoretical smooth fiber model provides a good fit to the experimental results, as shown in FIG. 7, there are still appreciable differences due to surface features. FIG. 8 depicts the correlation between filtration quality deviation and percentage of surface features between 200-400 nm. As shown in FIG. 8, to determine what the capture efficiency contribution is from the surface features, the percentage of surface features in the 200-400 nm size range can be cross-referenced with the filtration quality deviation between the measured results and the smooth fiber model (FIG. 7).

By directly comparing the deviation in filtration quality for 300 nm sized particles between the measured results and the calculated smooth fiber model to the percentage of surface area that has surface features between 200-400 nm in size, we find that there is a very high correlation with the r² value of 0.96 in a simple linear regression model, as shown in FIG. 8. This suggests that surface structure plays a prominent role in increasing filtration efficiency, with some samples showing over a 30% increase in filtration quality compared to smooth fibers. By approximating a linear relationship with the percentage increase in filtration quality and percentage of surface structures in the 200-400 nm range, a surface feature adjusted filtration quality can be derived as:

$${F}_{QSF} = 142 \cdot \frac{{ρ}_{i}^{\frac{3}{2}} \cdot t}{{ρ}_{f}^{\frac{1}{2}}} ( 1 + 0.019 P )$$

where P is the percentage of surface area that has 200-400 nm sized surface features, and thickness t in mm. This equation yields an excellent fit with the measured results, with a linear regression model r² value of 0.9991. The quality factor (Q) of the foams can be calculated as

$$Q ≡ \frac{v \cdot {F}_{QSF}}{Δ P} = - . 039 \frac{[ ln ( {ρ}_{f} ) + \frac{1 - {ρ}_{f}^{2}}{1 + {ρ}_{f}^{2}} ] \cdot ( 1 + 0.019 P )}{{ρ}_{i} \cdot {e}^{4.75 {ρ}_{f}}}$$

This allows for the optimization of the quality factor of the foam by tuning the initial and final densities of the foam. This can be seen in FIG. 5 whereby an ultra-low density 3.5% density foam (Sample 1) was able to achieve a quality factor of 5.02, over 50% better than a standard N-95 respirator which has a quality factor of around 3.20. While surface features were only controlled by adjusting the pH and additives of the secondary electrodeposition step for the study, there are several other methods to influence the surface structure as well. For instance, one method (explained further below) includes introducing 300 nm sized particles into the foam directly and sintering them onto the nanowires.

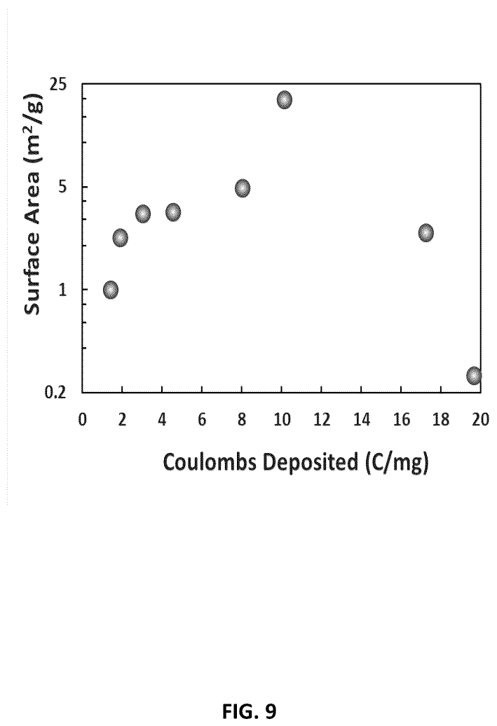

The surface area of the metal foam can also be optimized. Surface area is another important factor that can impact the filtration performance, which is intimately coupled with the foam microstructure. Initially the nanowires which comprise the foam have a relatively smooth surface structure as they were grown in an anodized aluminum oxide mold. However, during the secondary electrodeposition 2ED process the deposition of Cu nanogranules on the surface of the nanowires begin to dramatically increase the surface area. It was found that foams that were initially ˜3% bulk density pre-2ED exhibit a maximal surface area of 20 m²/g for a 13% bulk density after 2ED. As shown in FIG. 9, the surface area initially increases as the relative density increases, with the percentage density increase being measured in coulombs of copper deposited during the 2ED process per mg of 1ED foam. In foams with an even higher density, the deposited nanogranules begin to coalesce into a smoother surface structure and the surface area decreases.

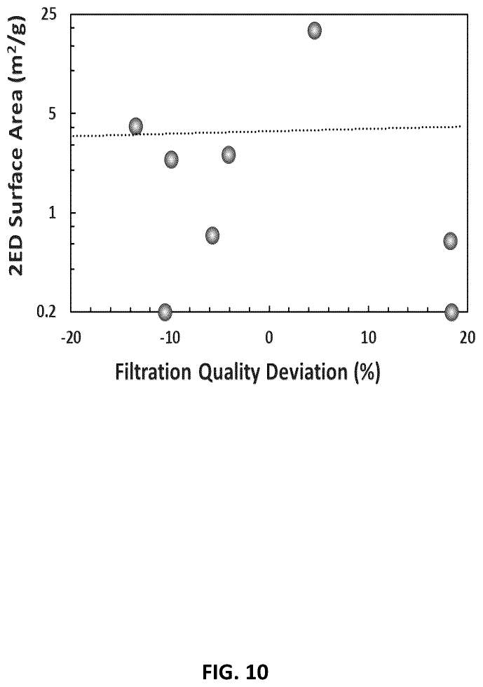

There is a substantial drop in filtration efficiency in the ρ_{f}=30% foam, whose surface area is more than an order of magnitude smaller than other foams with a lower ρ_{f}. With the 2ED process, the deposited surface features increase the internal surface area of the foam substantially, some by over a factor of 10 higher than what is predicted by the smooth fiber model, e.g., the aforementioned sample with a 20 m²/g surface area. The deposited surface features between 200-400 nm in size improves the capture efficiency for 300 nm size particles substantially. To determine how much the increased surface area from the foam's surface features might influence capture efficiency, additional surface area from 2ED is compared with the smooth fiber filtration quality model, as illustrated in FIG. 10, which illustrates that there appears to be no clear correlation with the increased surface area contributed from deposited surface features.

Still referring to FIG. 10, for foams with surface area in the >1 m²/g range, the additional surface area contribution from 2ED has no appreciable correlation with the capture efficiency of 300 nm sized particles, as a linear regression model yields a r² value of 2×10⁻⁵. This can be understood as the added surface area from 2ED is mostly from ultrasmall surface features that are simply too small relative to the 300 nm sized particles to enhance particle capture efficiency via nesting. This, combined with the trend shown in FIG. 10, implies that while surface area matters to the filtration efficiency, at the extremely high surface area regime of >1 m²/g, what is most relevant to PM_{0.3} efficiency is the characteristic size of the surface features, not just the total amount of increased surface area itself. On the other hand, increased surface area is still advantageous for a variety of applications such as neutralizing harmful compounds in the air via catalytic reactions or as heat exchangers. The metallic foams can be tuned to accommodate a wide range of catalytic reactions by adjusting the electrolyte used in the secondary plating process. For instance while copper is used in this study, copper-manganese, cobalt, palladium, and most other metallic catalysts could potentially be plated onto the surface of the nanowires instead. For expensive metals such as palladium, it is worth noting that by plating just a thin layer along the surface of the foams, a high surface area can be created with a minimal amount of material needed.

To achieve a more optimal filtration efficiency against the hardest-to-filter 300 nm sized particulates, it is desirable to maximize the number of surface features with sizes comparable to 300 nm. This can be accomplished by varying the synthesis conditions, as discussed above. In other example alternative embodiments, nanoparticles or nanowires of about 300 nm size can be incorporated into the foams directly during synthesis. The nanoparticles or nanowires can comprise, for example, Cu, Ni, Fe, Ag, Pd, Au, CuMn, TiO₂, ZnO, or other materials. These nanoparticles or nanowires may be incorporated at any steps of the foam synthesis, such as after enhancing the strength as described above, or at any step during the fabrication (e.g., during or after the first electrochemical deposition, during or after sintering, during the second electrochemical deposition, etc.). The incorporation of the 300 nm particles can be accomplished using electrochemical deposition. In example embodiments, a method that can be used to introduce 300 nm surface features is to soak the foam in a suspension of 300 nm sized nanoparticles suspended in deionized water, freeze them in place using liquid nitrogen, and then sublimate the ice in a vacuum leaving the particles uniformly coating the interior and exterior of the foam. Sintering the foam again will then cause the particles to permanently bond to the nanowires. The incorporation of the 300 nm particles can also be accomplished by using a polymer to bond the nanoparticles to the foam. Incorporating the 300 nm nanoparticles not only allows for efficient trapping of 300 nanometer sized particles, but can also increase the functionality of the metal foam by increasing its catalytic ability, depending on the material used. For example, Cu, Pd, CuMn are known to help with catalytic reactions, breaking down harmful gases. The result is not only that the filter physically traps particles, but can clean the air, for example by breaking down carbon dioxide into other benign species.

These foams serve as multifunctional filtration media, using their particulate filtration, air cleaning, and antimicrobial capabilities, as well as their robustness, reusability, and recyclability. The functionalities of each may be specifically enhanced to suit the needs of a given environment.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3º, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A method of constructing a free-standing metal foam, the method comprising:
electrochemically depositing a selected metal into one or more nanoporous templates to form metal nanowires employing a first electrolyte solution containing the selected metal;
dissolving the one or more nanoporous templates in a selected solution;
replacing some or all of the selected solution with water to produce a nanowire/water suspension;
freezing the nanowire/water suspension;
sublimating the water portion of the frozen nanowire/water suspension to produce the free-standing metal foam comprising a plurality of nanowires, wherein the density of the plurality of nanowires is increased; and further electrochemically depositing more of the selected metal, wherein the further electrochemically depositing comprises:
adjusting the amount of the selected metal deposited to vary the diameter of the plurality of nanowires,
adjusting a pH of a second electrolyte solution containing the selected metal, and
depositing the selected metal upon and throughout the free-standing metal foam so as to coat the plurality of nanowires of the free-standing metal foam, resulting in thickening of the free-standing metal foam around individual nanowires of the plurality of nanowires, as well as at intersections of multiple nanowires of the plurality of nanowires, thereby enhancing the free-standing metal foam's mechanical stability to enable the free-standing metal foam to withstand greater compressive stress than before the further electrochemically depositing step.

2. The method of claim 1, further comprising: sintering the free-standing metal foam prior to said further electrochemically depositing.

3. The method of claim 2, further comprising: during said sintering, performing multiple oxidation/reduction cycles upon the free-standing metal foam.

4. The method of claim 3, wherein each said oxidation/reduction cycle comprises:
exposing the free-standing metal foam to air; and
reducing the free-standing metal foam using a forming gas.

5. The method of claim 1, wherein said further electrochemically depositing results in an increase in the final foam density of the free-standing metal foam.

6. The method of claim 1, further comprising: coating at least a portion of the free-standing metal foam with a material selected from the group of coatings consisting of a metal, carbon, an oxide, a nitride, a chloride, a hydride, a fluoride, an iodide, and an amine.

7. The method of claim 1, wherein the free-standing metal foam features a pore size gradient across a dimension of the metal foam, including a plurality of nanometer to micron scale pores.

8. The method of claim 1, wherein enhancing the free-standing metal foam foam's mechanical stability comprises enabling it to support a load mass of at least one thousand times a mass of the free-standing metal foam without collapsing.

9. The method of claim 1, wherein the second electrolyte solution comprises a bath of copper sulfate along with a mixture of leveler, accelerator, and a suppressor compound.

10. The method of claim 1, wherein the pH is between 3-4.

11. A filtering apparatus synthesized from:
fabricating a metal foam comprising a plurality of interconnected nanowires, formed from a selected metal; and
incorporating nanoparticles of about 300 nm size into the metal foam during synthesis, wherein the presence of the nanoparticles enables the metal foam to filter 300 nm sized particulates.

12. The apparatus of claim 11, wherein incorporating the nanoparticles comprises depositing the nanoparticles using an electrochemical deposition process.

13. The apparatus of claim 11, wherein the incorporating comprises:
soaking the metal foam in a suspension of 300 nm sized nanoparticles suspended in deionized water;
freezing the metal foam in place using liquid nitrogen;
sublimating the metal foam that is frozen in a vacuum, leaving the 300 nm sized particles coating the metal foam's interior and exterior; and
sintering the metal foam again, resulting in the 300 nm sized particles bonding to the plurality of interconnected nanowires.

14. The apparatus of claim 11, wherein the nanoparticles have catalytic capabilities that can break down a gas.

15. The apparatus of claim 12, wherein the nanoparticles comprise one or more of Cu, Ni, Fe, Ag, Pd, Au, CuMn, TiO₂, and ZnO.

16. The apparatus of claim 11, wherein the incorporating comprises depositing the nanoparticles after an electrochemically depositing step in which the selected metal is deposited into one or more nanoporous templates to form the plurality of interconnected nanowires by employing an electrolyte solution containing the selected metal.

17. The apparatus of claim 16, wherein the electrochemically depositing step is a first electrochemically depositing step, and the incorporating further comprises a second electrochemically depositing step employed to strengthen the metal foam.

18. The apparatus of claim 11, wherein the incorporating comprises depositing the nanoparticles during a sintering of the metal foam.

19. The apparatus of claim 11, wherein the incorporating comprises depositing the nanoparticles after a sintering of the metal foam.

20. A system for constructing a free-standing metal foam comprising:
a first device for electrochemically depositing a selected metal into one or more nanoporous templates to form metal nanowires employing a first electrolyte solution containing the selected metal;
a second device for dissolving the one or more nanoporous templates in a selected solution;
a third device for replacing some or all of the selected solution with water to produce a nanowire/water suspension;
a fourth device for freezing the nanowire/water suspension;
a fifth device for sublimating the water portion of the frozen nanowire/water suspension to produce the free-standing metal foam; and
a sixth device for further electrochemically depositing more of the selected metal upon the free-standing metal foam.
